(19) United States
(12) Patent Application Publication
(10) Pub. No.: US 2007/0003288 A1
(43) Pub. Date: Jan. 4, 2007

(54) Bidirectional HDCP transmission module using single optical fiber

(76) Inventors: Xiaolin Tong, Irvine, CA (US); Shing-Wu P. Tzeng, Fountain Valley, CA (US); Hua Zhang, Los Angeles, CA (US); Randall Blair, Oceanside, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/173,409

(22) Filed: Jun. 30, 2005

(51) Int. Cl. H04B 10/12

(52) U.S. Cl. 398/142

(57) ABSTRACT

Techniques that provide cost effective optical fiber communication links for HDCP transmission systems and the like are provided. A single fiber for bidirectional communication is enabled, without wavelength selective unit to achieve the HDCP transmission. One embodiment of the present invention has a forward channel using a light source (e.g., VCSEL at about 850 nm) in the GHz modulation level (e.g., 1 GHz or greater), and a corresponding photodetector. The backward channel has a light source (e.g., LED at 630 nm) in the MHz modulation level (e.g., 10 MHz or less), and a corresponding photodetector. One application is for realizing a home entertainment system (e.g., DVD player and high definition television) that employs an HDCP-enabled communication link to transmit copy restricted digital content.

### FIELD OF THE INVENTION

The invention relates to optical transmission systems, and more particularly, to optical fiber link HDCP transmission systems and the like.

### BACKGROUND OF THE INVENTION

HDCP (high-bandwidth digital content protection) is a digital rights management specification developed by Intel Corporation to protect digital entertainment content across DVI (digital visual interface) or HDMI (high definition multimedia interface) connections. The HDCP specification, which is incorporated herein by reference, provides a robust, cost-effective and transparent method for transmitting and receiving digital entertainment content to DVI/HDMI-compliant digital displays (e.g., high definition television or flat panel such as plasma, LCD and/or DLP, etc).

In general, HDCP encrypts the transmission of digital content between the video source and the digital display. HDCP is not designed to prevent copying or recording of the digital content per se, but rather protects the integrity of content as transmitted. The video source or transmitter could be, for instance, a DVD player, a computer, or a set-top box. The digital display or receiver could be, for instance, as a digital television, monitor, or projector. Implementation of HDCP requires HDCP enabled devices to have a set of secret keys. During authentication, the receiving device will only accept content after it acknowledges the keys. To further protect the digital content, the transmitter and receiver generate a shared secret key value that is continuously checked throughout the transmission. After authentication is established, the transmitter encrypts the data and sends it to the receiver for decryption.

High-bandwidth transmission of digital content is usually achieved by one of two means: shielded copper wires (such as coaxial cable) or fiber optic cable. The first generation of HDCP transmission systems was realized using parallel shielded copper wire cables, such as DVI cables or HDMI cables. Due to band-width limits associated with this type of cable, a multiple parallel optical fiber link was introduced between transmitter and receiver. Conventional fiber systems typically employ at least two fiber links for HDCP applications.

A four fiber module configuration has three forward channels and one backward channel. It requires four lasers or other like light sources, four fiber links, and four receivers. A two fiber module configuration has one forward channel and one backward channel, and requires two lasers or other like light sources, two fiber links, and two receivers. For longer distance applications, the cost of multiple fibers is a concern. Other conventional bidirectional fiber communication techniques use wavelength selective units to achieve the HDCP transmission, thereby adding complexity and cost.

What is needed, therefore, are techniques that provide cost effective optical fiber communication links, for HDCP transmission systems and the like.

### SUMMARY OF THE INVENTION

One embodiment of the present invention provides a bidirectional HDCP transmission system using a single optical fiber having a core and cladding. The system includes a forward channel for delivering protected digital video and audio content, wherein the forward channel is substantially communicated in the core of the single optical fiber. The system also includes a backward channel for establishing an HDCP-enabled transmission, wherein the backward channel is at a lower data rate relative to the forward channel and is substantially communicated in the cladding of the single optical fiber. The forward channel may include, for example, a laser transmitter and a GHz range (e.g., 1 GHz, 2 GHz, or greater) photodetector. In such a case, the laser transmitter and GHz range photodetector can be optically coupled to the core of the single fiber directly, or by operation of a lens. The backward channel may include, for example, an LED transmitter and a MHz range (e.g., 10 MHz, 5 MHz, or less) photodetector. In such a case, the LED transmitter and MHz range photodetector can be optically coupled to the cladding of the single fiber directly or by operation of a lens. The forward channel laser transmitter and the backward channel MHz range photodetector can be integrated into a single package. Likewise, the backward channel LED transmitter and the forward channel GHz range photodetector can be integrated into a single package. In one particular embodiment, the forward channel includes a light source in the range of 800 nm to 1600 nm at a modulation level of 1 GHz or greater, and the backward channel includes a light source in the range of 400 nm to 750 nm at a modulation level of 10 MHz or less.

Another embodiment of the present invention provides a bidirectional protected digital content transmission system using a single optical fiber having a core and cladding. The system includes a forward channel for delivering protected digital content, wherein the forward channel is substantially communicated in the core of the single optical fiber. The systems also includes a backward channel for establishing a transmission of the protected digital content subject to one or more protection mechanisms, wherein the backward channel is at a lower data rate relative to the forward channel and is substantially communicated in the cladding of the single optical fiber. The forward channel may include, for example, a laser transmitter and a GHz range (e.g., 1 GHz, 2 GHz, or greater) photodetector that are included in a module that is adapted to operatively couple with at least one of a DVD player, a computer, and a set-top box. The backward channel may include, for example, an LED transmitter and a MHz range (e.g., 10 MHz, 5 MHz, or less) photodetector that are included in a module that is adapted to operatively couple with at least one of a digital television, a monitor, and a projector. In one particular configuration, there is an optical power difference between the forward channel and the backward channel of 10 dB to 30 dB (e.g., backward channel transmitter emits optical power about 20 dB lower than the forward channel transmitter).

Another embodiment of the present invention provides a device for bidirectional protected digital content transmission using a single optical fiber having a core and cladding. The device includes a forward channel circuit for one of transmitting or receiving protected digital content in the GHz range (e.g., 1 GHz, 2 GHz, or greater), wherein the content is substantially communicated in the core of the single optical fiber. The device also includes a backward channel circuit for one of transmitting or receiving protection scheme data in the MHz range (e.g., 10 MHz, 5 MHz, or less), wherein the data is substantially communicated in the cladding of the single optical fiber. The forward channel circuit may include, for example, a laser transmitter and the backward channel circuit includes a MHz range photodetector. Alternatively, the forward channel circuit may include, for example, a GHz range photodetector and the backward channel circuit includes an LED transmitter. The forward channel laser transmitter and the backward channel MHz range photodetector can be integrated into a single package. The backward channel LED transmitter and the forward channel GHz range photodetector can be integrated into a single package. The device can be adapted to operatively couple with at least one of a DVD player, a computer, a set-top box, a digital television, a monitor, and a projector. In one configuration, there is an optical power difference of 10 dB to 30 dB between signals transmitted by the forward channel circuit and signals transmitted by the backward channel circuit. The protection scheme data can be, for example, in accordance with HDCP, or some other digital management rights protection scheme.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1a is a block diagram of a bidirectional HDCP transmission system using a single optical fiber, configured in accordance with an embodiment of the present invention.

FIG. 1b illustrates forward and backward channels of the single fiber, in accordance with an embodiment of the present invention.

FIG. 2a is a block diagram of a transceiver module configured as the forward channel signal transmitter and backward channel signal receiver, for use in the bidirectional HDCP transmission system of FIG. 1a, in accordance with an embodiment of the present invention.

FIG. 2b illustrates a cross-sectional view of the transceiver module of FIG. 2a, configured in accordance with an embodiment of the present invention.

FIG. 2c illustrates a cross-sectional view of the single fiber of FIG. 2a, in accordance with an embodiment of the present invention.

FIG. 3a is a block diagram of a transceiver module configured as the backward channel signal transmitter and forward channel signal receiver, for use in the bidirectional HDCP transmission system of FIG. 1a, in accordance with an embodiment of the present invention.

FIG. 3b illustrates a cross-sectional view of the transceiver module of FIG. 3a, configured in accordance with an embodiment of the present invention.

### DETAILED DESCRIPTION OF THE INVENTION

Techniques that provide cost effective optical fiber communication links for HDCP transmission systems and the like are provided. A single fiber for bidirectional communication is enabled, without wavelength selective unit to achieve the HDCP transmission.

General Overview

To deploy a single fiber in bidirectional communication fashion, signal crosstalk has to be reduced or otherwise managed. One embodiment of the present invention has a forward channel using a light source (e.g., VCSEL) at, for example, about 850 nm, 1310 nm, or 1550 nm in the GHz modulation level (e.g., 1 GHz or greater). The backward channel has a light source (e.g., LED) at, for example, 630 nm in the MHz modulation level (e.g., 10 MHz or less).

The higher frequency light source and detector (e.g., PIN detector) of the forward channel are aligned at the center of the optical fiber, so as to communicatively couple with the core of the single fiber. The lower frequency light source and the detector (e.g., photodetector) of the backward channel are aligned off the center of the optical fiber, so as to communicatively couple with the cladding of the single fiber. The light source of the forward channel and the detector of the backward channel are located at one end of the fiber, and can be integrated into a single package (e.g., standard TO can or custom packaging). The detector of forward channel and the light source of the backward channel are located at the other end of the optical fiber, and can also be integrated into a single package.

An electric circuit (such as the circuitry included in a DVD player) is used to transform parallel digital audio/video signals into serial digital signals, and to modulate the forward channel light source based on the serial signals. The output optical power is then coupled into the forward channel of the optical fiber, in either multimode or single mode. At the receiving end of the forward channel, the detector receives the optical power intensity pattern from the fiber. Another electronic circuit (such as stand alone circuitry or the circuitry included in a high definition television or display panel receiver) recovers the detected serial data back to the original parallel digital audio/video signals, so that those signals can be displayed.

The lower frequency light source (e.g., LED) at the receiving end of the forward channel sends an encoded signal through the backward channel of the same optical fiber. The backward channel detector (e.g., photodetector) at the transmitter end of the forward channel decodes the lower frequency transmitted signal and gives permission to transmit the audio/video signal (via the forward channel) if the decoded signal is in agreement with the transmitter. In more detail, when HDCP is used, the end user device, such as a high definition television (HDTV) receiver, must first verify that the digital content (e.g., DVD movie) is licensed and allowed to be received (in accordance with the HDCP specification). If so, a handshake is exchanged (using the forward and backward channels) and the content is approved for transmission.

The forward optical power and backward optical power share the power distribution space. The optical power difference between the forward channel and the backward channel can be, for example, up to 20 dB. Note, however, that the power levels of the forward and backward channels can be the same as well. A lower power backward channel may contribute less interference. In any case, there is no need for a wavelength selective unit at either end of the optical fiber.

Bidirectional HDCP Transmission System

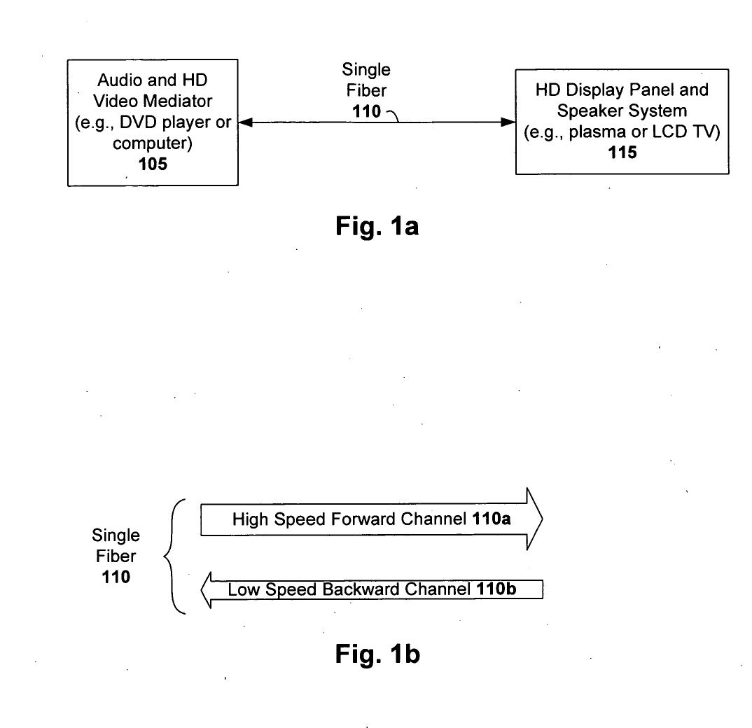

FIG. 1a is a block diagram of a bidirectional HDCP transmission system using a single optical fiber, configured in accordance with an embodiment of the present invention.

As can be seen, the system includes an audio and high definition (HD) video mediator 105 that is communicatively coupled to a high definition display panel and speaker system 115 via a single optical fiber 110. In a home entertainment system application, for example, the audio and high definition video mediator 105 can be a DVD player, computer, or set-top box, and the high definition display panel and speaker system 115 can be a high definition or digital television, monitor, or projector. A user could use the system to play movies, music, and the like.

Note, however, that the present invention is not intended to be limited to home entertainment applications, and can be used in a number of situations, as will be apparent in light of this disclosure. In general, the audio and high definition video mediator 105 can be any device or system that can output digital audio and/or video data that is content protected, and the high definition display panel and speaker system 115 can be any device or system that can display and/or sound the digital content transmitted from the audio and high definition video mediator 105.

Audio content includes, for instance, music, video sound tracks, audio books, machine messages (e.g., coded binary message for machine-to-machine communication), and human messages. Video content includes digital video, as well as other visual content such as presentations slides, graphical images, and digital art. In this example embodiment, an HDCP protection scheme is used. HDCP is used to protect the integrity of that digital audio/video content as transmitted, using an authentication handshake and encryption. In one embodiment of the present invention, HDCP is used to deliver uncompressed digital audio and/or video content using a high speed forward transmission (e.g., >1 GBPS) of a single fiber, and a lower speed backward transmission (e.g., <10 MBPS) of that same fiber.

FIG. 1b illustrates the high speed forward channel 110a and low speed backward channel 110b of the single fiber 110, which allow for bidirectional HDCP transmissions, in accordance with an embodiment of the present invention. As will be understood in light of this disclosure, the majority of the forward channel optical power stays in the core of the fiber, and the majority of the backward channel optical power stays in the cladding of the fiber. Even if some of the forward channel signals propagate into the backward channel detector, those signals will not significantly interfere with the backward channel communication. Likewise, even if the backward channel signals propagate into the forward channel detector, those signals will not significantly interfere with the forward channel communication. Thus, an HDCP-enabled transmission can be established and maintained using the high speed forward channel 110a and low speed backward channel 110b of the single fiber 110.

In addition, note that protection systems other than HDCP can be used here. In general, any protection scheme that uses a single fiber for a forward transmission having a first data rate (e.g., GHz range), and a backward transmission having a second data rate (e.g., MHz range) can be used here. The focus of the protection scheme may be on the legitimacy of the digital content being transmitted, or on some other aspect of the communication.

For instance, the backward channel can be used to establish if the content being accessed has expired (e.g., based on an embedded time stamp). Such a scheme could be used, for example, in applications that allow a user to have temporary access to audio content prior to making a purchase decision. Alternatively, the backward channel can be used to establish if the content is being accessed by an authorized machine or person (e.g., based on an authentication scheme). Such a scheme could be used, for example, in covert or otherwise secure applications. Alternatively, the backward channel can be used, for example, to establish if the content is being provided to the correct receiver (e.g., based on a target address). Such a scheme could be used in video on-demand applications.

Further note that any combination of such protection schemes can be used. Consider, for instance, a multicast transmission of protected video content. Here, a bidirectional HDCP transmission can be used in conjunction with a targeted address scheme, where only certain receiving nodes will be able to access and play the transmitted video content. Thus, both the legitimacy of the transmitted video content and the legitimacy of the viewer are established using a bidirectional transmission over a single fiber (for at least a portion of the communication link, such as between the viewer's house and the central office).

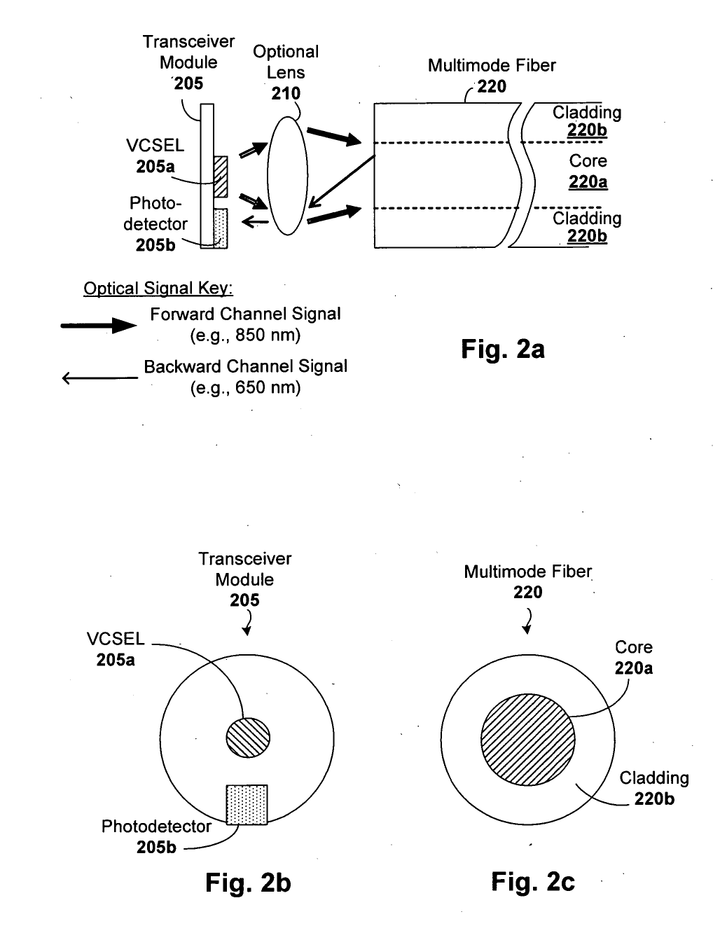

Transceiver modules configured in accordance with the principles of the present invention can be integrated with or otherwise operatively coupled in the audio and high definition video mediator 105 and high definition display panel and speaker system 115 of FIG. 1a to realize a bidirectional HDCP optical communication link, as will now be discussed with reference to FIGS. 2a-c and 3a-b.

Transceiver Module—Forward Channel TX and Backward Channel RX

FIG. 2a is a block diagram of a transceiver module configured as the forward channel signal transmitter and backward channel signal receiver, for use in the bidirectional HDCP transmission system of FIG. 1a, in accordance with an embodiment of the present invention. In particular, this transceiver module could be integrated with or otherwise operatively coupled in the audio and high definition video mediator 105 of FIG. 1a.

As can be seen, this embodiment includes a transceiver module 205 that is operatively coupled to a multimode fiber 220 via an optional lens 210. In other embodiments, the transceiver module 205 is directly coupled to the multimode fiber 220 (i.e., no lens). In this example configuration, the transceiver module 205 includes a VSCEL 205a for the forward channel transmitter and a photodetector 205b for the backward channel receiver. In one particular embodiment, the VSCEL 205a and photodetector 205b are packaged into a single can or other suitable package.

FIG. 2b illustrates a cross-sectional view of the transceiver module 205. In one embodiment, the light source 205a and the detector 205b are packaged about 20 to 80 μm apart in the same can FIG. 2c illustrates a cross-sectional view of the single multimode fiber 220, which includes a core 220a and a cladding 220b. In one embodiment, the multimode fiber 220 has a 0.062 mm core and 0.125 mm cladding, although there are numerous fiber dimensions that could be used. As previously discussed, the optical power of the forward channel stays mainly within the core 220a and the optical power of the backward channel stays mainly in the cladding 220. There are overlaps in optical distributions, which do not impact communications of the channels.

The VSCEL 205a of the forward channel is this example is about 850 nm, although other light source wavelengths can be used (e.g., 1310 nm or 1550 nm light sources). This forward channel is operated at a higher data rate relative to the backward channel. In one particular embodiment, the forward channel is operated at the GHz modulation level (e.g., 2 GHz or greater). The photodetector 205b of the backward channel of this embodiment is configured for detecting light at about 650 nm, although other detectable wavelengths can be used (e.g., 600 nm or 630 nm or 700 nm). This backward channel is operated at a lower data rate relative to the forward channel. In one particular embodiment, the backward channel is operated at the MHz modulation level (e.g., 10 MHz or less).

The VCSEL 205a (or other suitable light source) of the forward channel is aligned at the core 220a of the fiber 220. The optional lens 210 can be used to focus the light emitted from the VCSEL 205a to the core 220a of the fiber 220. Alternatively, the light emitted from the VCSEL 205a can be coupled directly to the core 220a of the fiber 220. Note that in such a case, the transceiver module 205 can be fabricated with the VCSEL 205a sized and located to facilitate the direct optical coupling with the core 220a of the fiber 220 (e.g., where the transmission window of the VCSEL 205a abuts the core 220a of the fiber 220). In one particular embodiment, the transmission window of the VCSEL 205a is about 10 to 40 microns across (e.g., square, circular, or irregular shape), and the core 220a of the fiber 220 is about 62.5 microns in diameter.

The photodetector 205b of the backward channel is aligned with the cladding 220b of the optical fiber 220. The optional lens 210 can be used to focus the light received from the cladding 220b to the photodetector 205b of the transceiver module 205. Alternatively, the light received from the cladding 220b can be coupled directly to the photodetector 205b of the transceiver module 205. Note that in such a case, the transceiver module 205 can be fabricated with the photodetector 205b sized and located to facilitate the direct optical coupling with the cladding 220b of the fiber 220 (e.g., where the active area of the photodetector 205b abuts the cladding 220b of the fiber 220). In one particular embodiment, the active area of the photodetector 205b is about 80 to 100 microns across (e.g., square, circular, or irregular shape), and the core 220a of the fiber 220 is about 62.5 microns in diameter. Note, however, that the active area of the photodetector 205b can be larger (e.g., 100 to 500 microns across, or more).

Transceiver Module—Backward Channel TX and Forward Channel RX

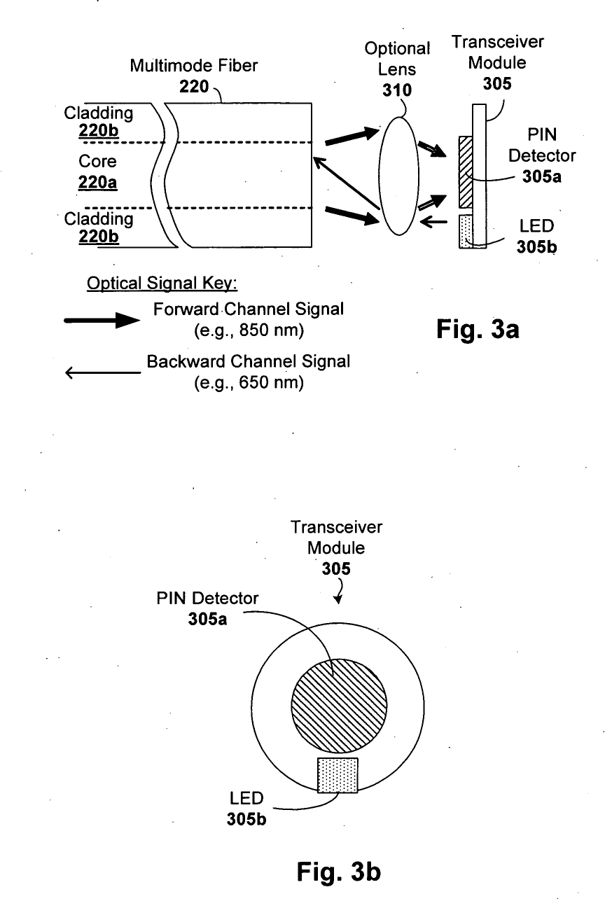

FIG. 3a is a block diagram of a transceiver module configured as the backward channel signal transmitter and forward channel signal receiver, for use in the bidirectional HDCP transmission system of FIG. 1a, in accordance with an embodiment of the present invention. In particular, this transceiver module could be integrated with or otherwise operatively coupled in the high definition display panel and speaker system 115 of FIG. 1a. As will be understood in light of this disclosure, FIGS. 2a-c and FIG. 3-b demonstrate a bidirectional (i.e., forward and backward channels) optical communication link, using a single fiber 220.

As can be seen, this embodiment includes a transceiver module 305 that is operatively coupled to the multimode fiber 220 via an optional lens 310. In other embodiments, the transceiver module 305 is directly coupled to the multimode fiber 220 (i.e., no lens). In this example configuration, the transceiver module 305 includes a PIN detector 305a for the forward channel receiver and an LED 305b for the backward channel transmitter. In one particular embodiment, the PIN detector 305a and LED 305b are packaged into a single can or other suitable package.

FIG. 3b illustrates a cross-sectional view of the transceiver module 305. In one embodiment, the detector 305a and the light source 305b are packaged about 20 to 80 μm apart in the same can. Assume the multimode fiber 220 is as previously discussed with reference to FIG. 2c, and includes a core 220a and a cladding 220b. Recall that in one such embodiment, the multimode fiber 220 has a 0.062 mm core and 0.125 mm cladding, although there are numerous fiber dimensions that could be used. As previously discussed, the forward channel optical power stays mainly within the core 220a and the backward channel optical power stays mainly in the cladding 220, with some degree of overlap in optical power distributions.

The LED 305b of the backward channel is this example is about 650 nm, although other light source wavelengths can be used (e.g., 600 nm or 630 nm or 700 nm). This backward channel is operated at a lower data rate relative to the forward channel. In one particular embodiment, the backward channel is operated at the MHz modulation level (e.g., 10 MHz or less). The PIN detector 305a of the forward channel of this embodiment is doped or otherwise configured for detecting light at about 850 nm, although other detectable wavelengths can be used (e.g., 1310 nm or 1550 nm light sources). As previously explained, this forward channel is operated at a higher data rate relative to the backward channel. In one particular embodiment, the forward channel is operated at the GHz modulation level (e.g., 2 GHz or more).

The LED 305b (or other suitable light source) of the backward channel is aligned with the cladding 220b of the optical fiber. The optional lens 310 can be used to focus the light emitted from the LED 305b to the cladding 220b of the fiber 220. Alternatively, the light emitted from the LED 305b can be coupled directly to the cladding 220b of the fiber 220. Note that in such a case, the transceiver module 305 can be fabricated with the LED 305b sized and located to facilitate the direct optical coupling with the cladding 220b of the fiber 220 (e.g., where the transmission window of the LED 305b or the LED 305b itself abuts the cladding 220b of the fiber 220). In one particular embodiment, the transmission window of the LED 305b is about 10 to 40 microns across (e.g., square, circular, or irregular shape), and the cladding 220b of fiber 220 is about 125 microns in diameter.

The PIN detector 305a (or other light source) of the forward channel is aligned at the core 220a of the optical fiber 220. The optional lens 310 can be used to focus the light received from the core 220a of the fiber 220 to the PIN detector 305a. Alternatively, the light received from the core 220a of the fiber 220 can be coupled directly to the PIN detector 305a. Note that in such a case, the transceiver module 305 can be fabricated with the PIN detector 305a sized and located to facilitate the direct optical coupling with the core 220a of the fiber 220 (e.g., where the active area of the PIN detector 305a abuts the core 220a of the fiber 220). In one particular embodiment, the active area of the PIN detector 305a is about 80 to 100 microns across (e.g., square, circular, or irregular shape), and the core 220a of the fiber 220 is about 62.5 microns in diameter. Note, however, that the active area of the photodetector 205b can be larger (e.g., 100 to 500 microns across, or more). Smaller sizes may be desirable, however, given various design constraints.

Thus, transceiver modules configured in accordance with the principles of the present invention can be integrated with or otherwise operatively coupled into nodes of an optical communication system to realize a bidirectional HDCP optical communication link, as discussed with reference to FIGS. 2a-c and 3a-b. None of the communicating nodes require a wavelength selective unit, as is typically used in the telecommunication industry.

The foregoing description of the embodiments of the invention has been presented for the purposes of illustration and description. It is not intended to be exhaustive or to limit the invention to the precise form disclosed. Many modifications and variations are possible in light of this disclosure.

For instance, a bidirectional communication channel using a single fiber, where optical power of a high speed forward channel is substantially transmitted in the core of the single fiber, and optical power of a lower speed backward channel is substantially transmitted in the cladding of the single fiber can be used in a number of optical communication applications, in addition to HDCP applications or other protection scheme applications. For example, the forward channel can be used to deliver payload data, while the backward channel can be used to deliver link management or overhead information, such as transmission statistics (e.g., amount of payload delivered and transmission time) and customer data (e.g., credit card info, movie selection, and subscriber feedback).

It is intended that the scope of the invention be limited not by this detailed description, but rather by the claims appended hereto.

What is claimed is:

1. A bidirectional HDCP transmission system using a single optical fiber having a core and cladding, the system comprising:
a forward channel for delivering protected digital video and audio content, wherein the forward channel is substantially communicated in the core of the single optical fiber; and
a backward channel for establishing an HDCP-enabled transmission, wherein the backward channel is at a lower data rate relative to the forward channel and is substantially communicated in the cladding of the single optical fiber.

2. The system of claim 1 wherein the forward channel includes a laser transmitter and a GHz range photodetector.

3. The system of claim 2 wherein the laser transmitter and GHz range photodetector are optically coupled to the core of the single fiber directly or by operation of a lens.

4. The system of claim 1 wherein the backward channel includes an LED transmitter and a MHz range photodetector.

5. The system of claim 4 wherein the LED transmitter and MHz range photodetector are optically coupled to the cladding of the single fiber directly or by operation of a lens.

6. The system of claim 1 wherein the forward channel includes a light source in the range of 800 nm to 1600 nm at a modulation level of 1 GHz or greater, and the backward channel includes a light source in the range of 400 nm to 750 nm at a modulation level of 10 MHz or less.

7. The system of claim 1 wherein the forward channel includes a laser transmitter and a GHz range photodetector, and the backward channel includes an LED transmitter and a MHz range photodetector.

8. The system of claim 7 wherein the forward channel laser transmitter and the backward channel MHz range photodetector are integrated into a single package.

9. The system of claim 7 wherein the backward channel LED transmitter and the forward channel GHz range photodetector are integrated into a single package.

10. The system of claim 1 wherein the forward channel includes a laser transmitter and a GHz range photodetector that are included in a module that is adapted to operatively couple with at least one of a DVD player, a computer, and a set-top box.

11. The system of claim 1 wherein the backward channel includes an LED transmitter and a MHz range photodetector that are included in a module that is adapted to operatively couple with at least one of a digital television, a monitor, and a projector.

12. The system of claim 1 wherein there is an optical power difference between the forward channel and the backward channel of 10 dB to 30 dB.

13. A bidirectional protected digital content transmission system using a single optical fiber having a core and cladding, the system comprising:
a forward channel for delivering protected digital content, wherein the forward channel is substantially communicated in the core of the single optical fiber; and
a backward channel for establishing a transmission of the protected digital content subject to one or more protection mechanisms, wherein the backward channel is at a lower data rate relative to the forward channel and is substantially communicated in the cladding of the single optical fiber.

14. The system of claim 13 wherein the forward channel includes a laser transmitter and a GHz range photodetector, and the backward channel includes an LED transmitter and a MHz range photodetector.

15. The system of claim 13 wherein the forward channel includes a laser transmitter and a GHz range photodetector that are included in a module that is adapted to operatively couple with at least one of a DVD player, a computer, and a set-top box.

16. The system of claim 13 wherein the backward channel includes an LED transmitter and a MHz range photodetector that are included in a module that is adapted to operatively couple with at least one of a digital television, a monitor, and a projector.

17. The system of claim 13 wherein there is an optical power difference between the forward channel and the backward channel of 10 dB to 30 dB.

18. A device for bidirectional protected digital content transmission using a single optical fiber having a core and cladding, the device comprising:
a forward channel circuit for one of transmitting or receiving protected digital content in the GHz range, wherein the content is substantially communicated in the core of the single optical fiber; and
a backward channel circuit for one of transmitting or receiving protection scheme data in the MHz range, wherein the data is substantially communicated in the cladding of the single optical fiber.

19. The device of claim 18 wherein the forward channel circuit includes a laser transmitter and the backward channel circuit includes a MHz range photodetector, or the forward channel circuit includes a GHz range photodetector and the backward channel circuit includes an LED transmitter.

20. The device of claim 19 wherein the forward channel laser transmitter and the backward channel MHz range photodetector are integrated into a single package.

21. The device of claim 19 wherein the backward channel LED transmitter and the forward channel GHz range photodetector are integrated into a single package.

22. The device of claim 18 wherein the device is adapted to operatively couple with at least one of a DVD player, a computer, and a set-top box.

23. The device of claim 18 wherein the device is adapted to operatively couple with at least one of a digital television, a monitor, and a projector.

24. The device of claim 18 wherein there is an optical power difference of 10 dB to 30 dB between signals transmitted by the forward channel circuit and signals transmitted by the backward channel circuit.

25. The device of claim 18 wherein the protection scheme data is in accordance with HDCP.
